(19) United States
(12) Patent Application Publication
(10) Pub. No.: US 2016/0086512 A1
(43) Pub. Date: Mar. 24, 2016

(54) SERVER APPARATUS, METHOD OF AGGREGATING CALCULATION TARGET DATA, AND STORAGE MEDIUM STORING CALCULATION DATA AGGREGATION PROGRAM

(71) Applicant: CASIO COMPUTER CO., LTD., Tokyo (JP)

(72) Inventor: Hiroaki YOSHIZAWA, Ome-shi (JP)

(73) Assignee: CASIO COMPUTER CO., LTD., Tokyo (JP)

(21) Appl. No.: 14/855,159

(22) Filed: Sep. 15, 2015

(30) Foreign Application Priority Data
Sep. 19, 2014 (JP) 2014-191868

(51) Int. Cl. G09B 19/02; G06F 15/02

(52) U.S. Cl. CPC G09B 19/025; G06F 15/0225

(57) ABSTRACT

A server apparatus has a transmission/reception unit and a processor that is configured to transmit a group ID to the communication device by using the transmission/reception unit, receive a plurality of calculation data of calculators from the communication device by using the transmission/reception unit, wherein corresponding images of the plurality of calculation data of calculators were displayed in display devices of calculators, and the plurality of calculation data of calculators of the corresponding images were acquired by the communication device, and output aggregated calculation data acquired by aggregating the received plurality of calculation data of calculators in association with the group ID.

### CROSS-REFERENCE TO RELATED APPLICATIONS

This application is based upon and claims the benefit of priority from Japanese Patent Application No. 2014-191868, filed Sep. 19, 2014, the entire contents of which are incorporated herein by reference.

### BACKGROUND OF THE INVENTION

1. Field of the Invention

The present invention relates to a server apparatus aggregating calculation target data, a method of aggregating calculation target data, and a storage medium storing calculation data aggregation program.

2. Description of the Related Art

Conventionally, information display devices called scientific electronic calculators used for learning calculation processes of various function expressions are widely used.

As a use form of such information display devices, in Jpn. Pat. No. 4720607, it has been proposed that, in a class of a school or the like for displaying and analyzing the graph of a function expression, each student uses a scientific electronic calculator, and a scientific electronic calculator used by a teacher receives calculation target data such as graph data from the scientific electronic calculator of each student that is transmitted through infrared communication or the like, aggregates the received calculation target data, and projects and displays the aggregated calculation data as a result of the aggregation in an enlarged scale.

Meanwhile, in recent years, calculation servers have been provided each accessed by a communication device such as a smartphone and providing a calculation service of a high-level function on the Internet.

In Jpn. Pat. No. 4720607, a communication function is provided in the scientific electronic calculator of each student, and it is necessary for each information display device to be associated in advance and to be communicably connected to a teacher's communication device.

For this reason, there is a problem in that, generally, such a structure cannot be used by a low-cost scientific electronic calculator, which is provided with an input device and a display device, used by each student.

### BRIEF SUMMARY OF THE INVENTION

Accordingly, it is an object of the present invention to provide a server apparatus that easily registers calculation data of a calculator (electronic calculator) including a display device as a group and is capable of outputting an aggregation result data that is a result of the aggregation of a plurality of calculation data.

According to one aspect of the present invention, there is provided a server apparatus including a transmission/reception unit that transmits/receives data to/from a communication device, and a processor. The processor is configured to transmit a group ID to the communication device by using the transmission/reception unit; receive a plurality of calculation data of calculators from the communication device by using the transmission/reception unit, wherein corresponding images of the plurality of calculation data of calculators were displayed in display devices of calculators, and the plurality of calculation data of calculators of the corresponding images were acquired by the communication device; and output aggregated calculation data acquired by aggregating the received plurality of calculation data of calculators in association with the group ID.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1A is an outline view of a scientific electronic calculator as an information display device associated with a calculation server relating to a server apparatus according to a first embodiment of the present invention;

FIG. 1B is a schematic diagram showing a use form of the calculation server relating to the server apparatus according to the first embodiment of the present invention;

FIG. 2 is a diagram showing the circuit configuration of a scientific electronic calculator as an information display device;

FIG. 3 is a diagram showing the circuit configuration of the calculation server;

FIG. 4 is a diagram showing a flowchart of a server process executed by the calculation server;

FIG. 5 is a diagram including part (A) showing an example of a screen for checking a class ID as a group ID and a mail address as transmission destination information in a communication device used for a teacher, and including parts (B), (C), (D), and (E) showing an example of a user operation for a scientific electronic calculator of each student and a display output corresponding thereto, and including part (F) showing a display example in a communication device used for a student;

FIG. 6 is a diagram showing a flowchart of a display control process executed by a scientific electronic calculator;

FIG. 7 is a diagram including parts (A), (B), (C), and (D) showing an example of user operations for scientific electronic calculators of mutually-different students and display outputs corresponding thereto, and including parts (E) and (F) showing display examples in communication devices for the mutually-different students;

FIG. 8 is a diagram including part (A) showing a display example of aggregated calculation data in a communication device used for a student, and including part (B) showing a display example of aggregated calculation data in a communication device used for a teacher;

FIG. 9A is a diagram showing a first change portion, which is changed from the flowchart illustrated in FIG. 4, of the flowchart of a server process executed by a calculation server relating to a server apparatus according to a second embodiment of the present invention;

FIG. 9B is a diagram showing a second change portion, which is changed from the flowchart illustrated in FIG. 4, of the flowchart of the server process;

FIG. 10 is a diagram including parts (A) and (B) showing display examples in a communication device used for a teacher for registering a form in the second embodiment, and including parts (C) and (D) showing examples of user operations for a teacher's scientific electronic calculator for registering a form and display outputs corresponding thereto, and including part (E) showing a display example in a communication device used for a teacher when the registration of a form ends; and

FIG. 11 is a diagram including parts (A) and (B) showing examples of user operations for a scientific electronic calculator of each student and display output corresponding thereto, and including part (C) showing a display example of a communication device used for a student at the time of no-matching of the form, and including part (D) showing a display example of a communication device used for a student at the time of matching the form.

### DETAILED DESCRIPTION OF THE INVENTION

Hereinafter, embodiments of the present invention will be described with reference to the drawings.

### First Embodiment

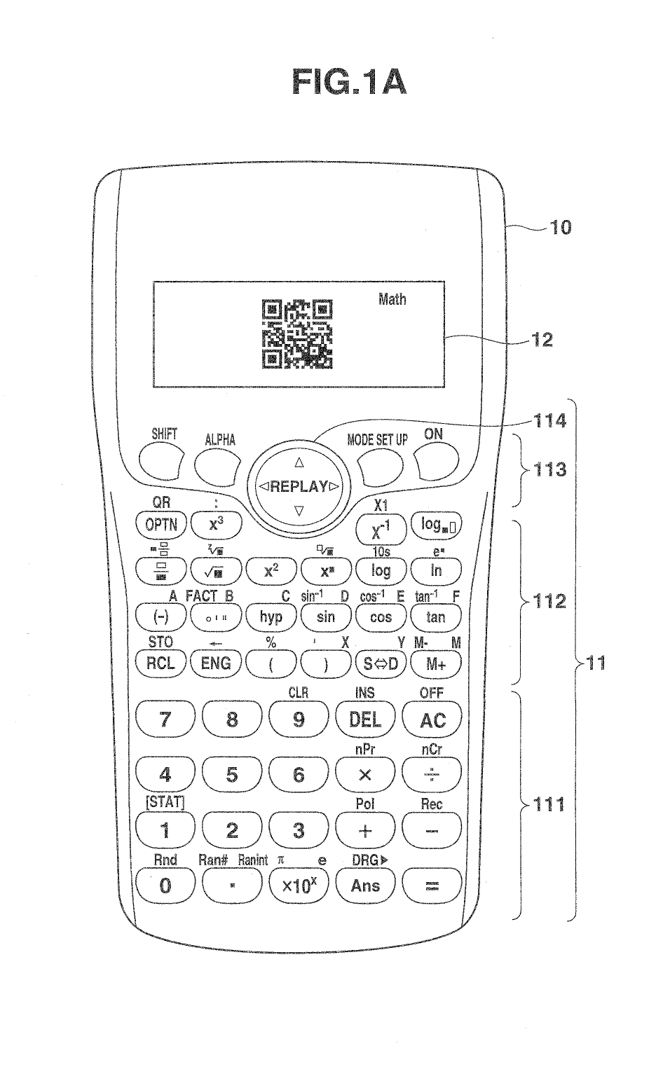

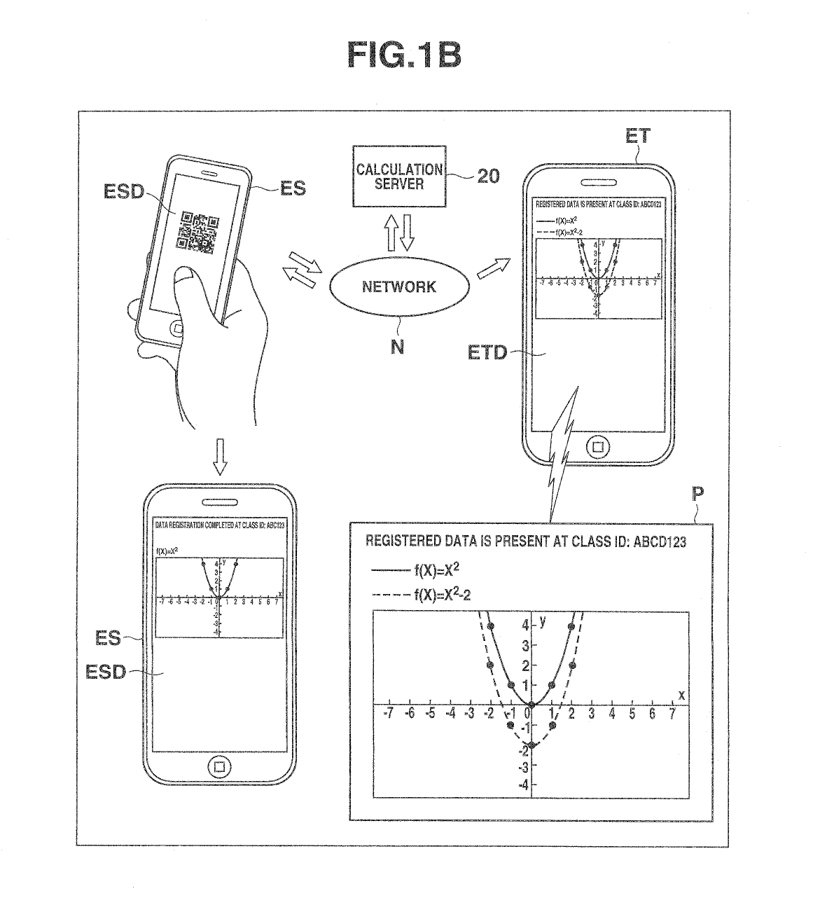

Here, as illustrated in FIGS. 1A and 1B, a system will be described as an example which is configured by: a scientific electronic calculator 10 as an information display device used by each student; a communication device ES used for a student such as a camera-attached smartphone used by each student that photographs an image of a two-dimensional code such as a QR code (registered trademark) that is displayed and output from the scientific electronic calculator 10 of each student; a calculation server 20 relating to a server apparatus according to a first embodiment of the present invention that receives calculation target data transmitted from the communication device ES used for a student through a communication network N such as the Internet in accordance with data of the content of the photographed two-dimensional code and acquires aggregated calculation result data of calculation results by aggregating the calculation target data from the communication device ES used for a student; a communication device ET for a teacher such as a smartphone used by a teacher that receives the aggregated calculation result data acquired by the calculation server 20 through the communication network N and displays and outputs the aggregated calculation result data; and a projector P that projects and displays the aggregated calculation result data displayed and output by the communication device ET used for a teacher in an enlarged scale.

Here, the communication device ES used for a student is not limited to the camera-attached smartphone but may be configured as a camera-attached personal digital assistants (PDA), a camera-attached tablet PC, a camera-attached or camera-connected notebook personal computer (PC), or the like.

Similarly, the communication device ET used for a teacher is not limited to a smartphone but may be configured as a PDA, a tablet PC, a notebook PC, an electronic blackboard, or the like. In FIGS. 1A and 1B, while two communication devices ES used for students are illustrated, this is only for representing separate units so as to represent transitions of a display output device ESD that are at the time of photographing the two-dimensional code and at the time of receiving the calculation result data, and actually, one communication device ES for a student is illustrated. In addition, while one scientific electronic calculator 10 and one communication device ES for a student are representatively illustrated, actually, scientific electronic calculators 10 and communication devices ES used for students corresponding to the number of students are included. In addition, one scientific electronic calculator 10 used for a teacher may be further included.

According to the need for the portability, the scientific electronic calculator 10 has a small size that can be sufficiently held by a user using one hand and can be operated by using one hand, and, on the front face of the main body of the scientific electronic calculator 10, a key input device 11 and a display output device 12 are arranged.

The key input device 11 includes: a numeric/operation symbol key group 111 used for inputting a numerical value or a numerical expression and giving an instruction for the execution of calculation; a function key group 112 used for inputting various functions and starting up a memory function; a mode setting key group 113 used for displaying a menu screen of various operation modes and giving an instruction for setting an operation mode; and a cursor key 114 used for executing an operation of moving a cursor displayed on the display output device 12, an operation of selecting a data item, or the like.

As the numeric/operation symbol key group 111, [0] to [9] (numeric) keys, [+] [−] [×] [÷] (four rules of arithmetic) keys, [Ans][=] (execution) keys, an [AC] (clear) key, and the like are arranged.

As the function key group 112, starting from an [x⁻¹] (“−1st” power: inverse) key, a [√ ] (root) key, a [/] (fraction) key, a [sin] (sine) key, a [M+] (memory plus) key, an [OPTN] (option) key, a [RCL] (memory call), key and the like are arranged.

As the mode setting key group 113, a [MODE] (mode) key, a [SHIFT] (shift) key, an [ALPHA] (alphabet) key, an [ON] (power on) key, and the like are arranged.

In addition, by operating (simultaneously pressing) a key of the numeric/operation symbol key group 111 and the function key group 112 key simultaneously with the [SHIFT] key, the key can serve as not a key function described at the key top but a key described on the upper side of the key. For example, a simultaneous operation of the [SHIFT] key and the [AC] key (hereinafter, described as [SHIFT]+[AC] key) serve as an [OFF] (power off) key. In addition, a [SHIFT]+[OPTN] key serves as a [QR] (QR) key, and a [SHIFT]+[RCL] key serves as an [STO] (memory registration) key.

The display output device 12 is configured by a liquid crystal display device of a dot matrix type.

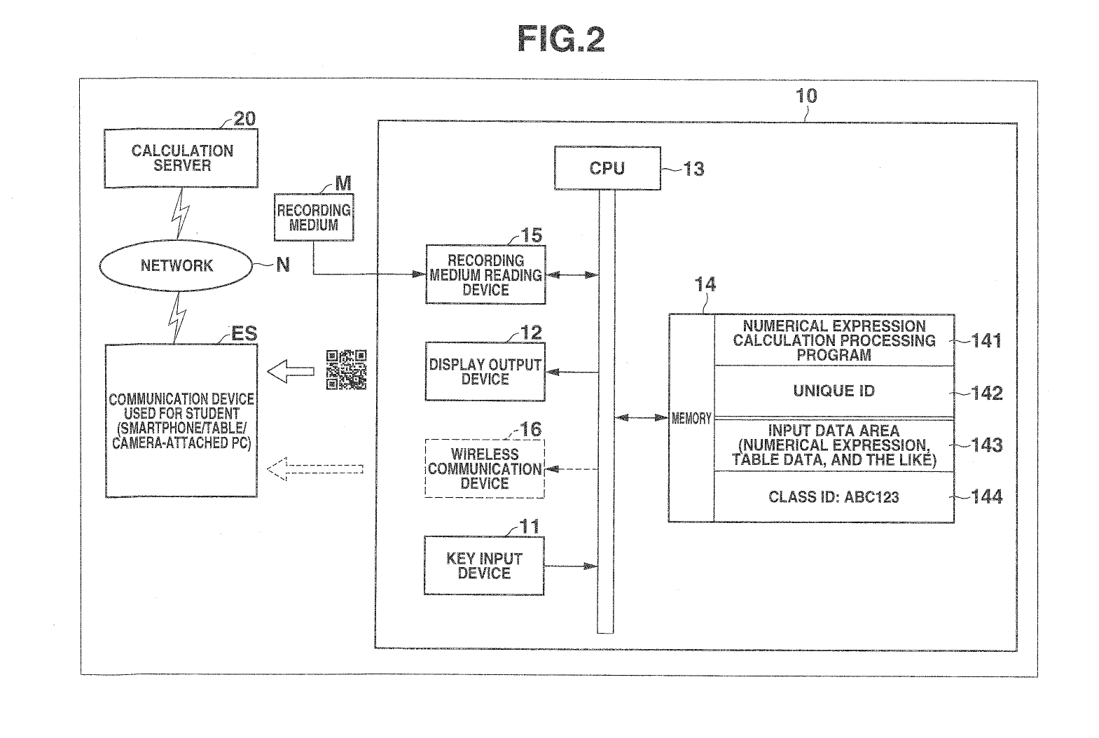

FIG. 2 is a block diagram showing the configuration of the electronic circuit of the scientific electronic calculator 10.

In addition to the key input device 11 and the display output device 12, the electronic circuit of the scientific electronic calculator 10 includes a CPU 13 that is a computer; a memory 14; and a recording medium reading device 15. In addition, as denoted by broken lines in the figure, a wireless communication device 16 may be included.

The CPU 13 controls the operation of each circuit in accordance with a numerical expression calculation processing program 141 stored in a memory 14 and executes various calculation processes according to a key input signal transmitted from the key input device 11. This numerical expression calculation processing program 141 may be stored in the memory 14 in advance or may be read from an external recording medium M such as a memory card through a recording medium reading device 15 into the memory 14 so as to be stored therein. This numerical expression calculation processing program 141 is configured not to be overwritten by a user's operation for the key input device 11.

In addition, in the memory 14, as user non-overwritable information, a unique ID 142 is stored. This unique ID 142 is an ID that is unique to each of the scientific electronic calculators 10.

In the memory 14, in addition to such user non-overwritable information, an input data area 143 and a group ID memory 144 are secured for storing data that can be overwritten by the user.

Here, data of key codes input through keys by the key input device 11 is sequentially input to the input data area 143, and data of a numerical expression or table data configured by the data is stored in the input data area 143. For example, a numeric key is stored as a code representing a number, a function key such as “sin” key is stored as a code representing the function, and an arithmetic symbol key such as “+”, “−”, “×” or “÷” is stored as a code representing the arithmetic symbol. In addition, in this input data area 143, variables of other numerical values that are individually registered in nine characters of A, B, C, D, E, F, M, X, and Y are also stored. For example, by executing key operations of the [3] key, the [SHIFT]+[RCL] key (=[STO] key), and the [(−)] key (=the [A] key) of the key input device 11, a numerical value “3” is registered in the variable A. In addition, a function type such as a function table function set according to the operation of the [MODE] key of the key input device 11 or other data that is necessary for the calculation of a numerical expression, for example, a calculation range are also stored. The calculation range includes an initial value, a final value, and a step (increment).

The group ID memory 144 stores a group ID. This group ID is input through keys by using the key input device 11 and is a class ID that is set for each group, for example, for each class by a teacher, Thus, each student who is a user using the scientific electronic calculator 10 sets and registers the class ID as a group ID to the scientific electronic calculator 10 according to a teacher's instruction.

In addition, the wireless communication device 16 has a function for executing wireless communication such as Bluetooth (registered trademark) or infrared communication with an external communication device ES used for a student.

The scientific electronic calculator 10 configured in this way realizes a display control function, which will be described in the following description of the operations, of generating a two-dimensional code, in this embodiment, a QR code of the unique ID of the scientific electronic calculator 10, the function type (for example, the function of a function table) input from the key input device 11, calculation target data for each function (for example, a function expression and a calculation range), and the other data (for example, a variable and a calculation range) and displaying and outputting the generated code by using the display output device 12 as the CPU 13 controls the operation of each circuit in accordance with an instruction described in the numerical expression calculation processing program 141 so as to cause software and hardware to operate in a cooperative manner.

The communication device ES used for a student photographs an image of the QR code that is output to be displayed on the display output device 12 of the scientific electronic calculator 10 and transmits data (hereinafter, referred to as QR data) of the content of the photographed QR code to the calculation server 20 of which the address is set in advance through the communication network N.

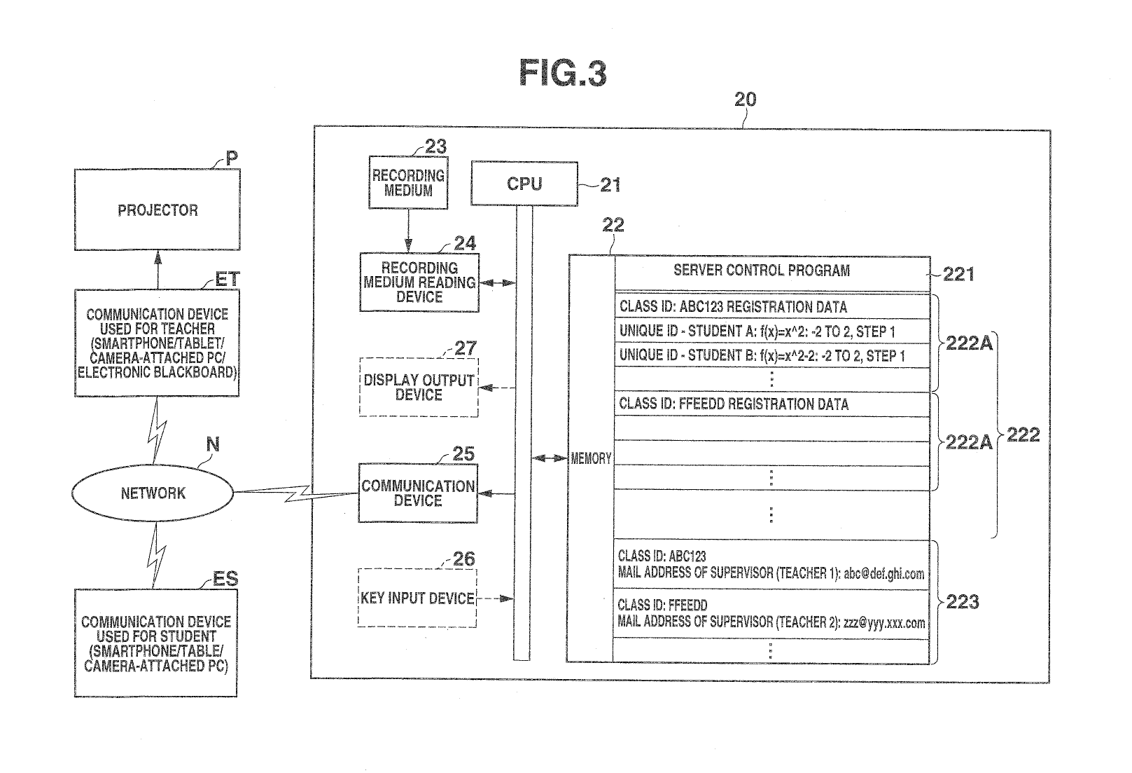

FIG. 3 is a block diagram showing the configuration of the electronic circuit of the calculation server 20.

The electronic circuit of the calculation server 20 includes: a CPU 21 that is a computer; a memory 22; a recording medium 23; a recording medium reading device 24; and a communication device 25. In addition, as denoted by broken lines in the figure, a key input device 26 or a display output device 27 may be included.

The CPU 21 executes various calculation processes according to the QR data received from the camera-attached communication device E, which is received by the communication device 25, by controlling the operation of each circuit according to a server control program 221 that is stored in the memory 22 in advance, is read into the memory 22 from the recording medium 23 such as a memory card through the recording medium reading device 24, or is downloaded into the memory 22 from a web server not illustrated in the figure on the communication network N through the communication device 25.

In the memory 22, the server control program 221 is stored, and a registration data memory 222 in which the QR data received from each communication device ES used for a student through the communication device 25 is registered for each group ID and a group ID memory 223 in which a plurality of group IDs are stored in association with transmission destination information are secured. Here, in the registration data memory 222, a dedicated data area 222A is generated for each group ID, and the QR data received for each student can be registered therein as class data. In this embodiment, while the transmission destination information is set as a teacher's mail address, the transmission destination information may be a unique ID of the communication device ET used for a teacher or the like. The transmission destination group and the group ID are arbitrarily set by the communication device ET used for a teacher in advance, and the registration data memory 222 for the group ID is secured in accordance with the setting thereof.

In addition, the server control program 221 has a function for executing a setting operation or a maintenance operation in accordance with a setting operation, a maintenance operation, or the like of the key input device 26 that is executed by an operator of the calculation server 20, a function for displaying the development process or the result of the operation on the display output device 27, and the like.

The calculation server 20 configured in this way realizes a server processing function as presented in the following description of operations in which the CPU 21 operates software and hardware in a cooperative manner by controlling the operation of each circuit in accordance with an instruction described in the server control program 221, specifically, by calculating a numerical expression based on the received QR data for each student, transmitting single calculation result data that is a result of the calculation to the communication device ES used for a student that is the transmission source of the received QR data; and executing calculation by aggregating the received QR data of a plurality of students, and transmitting aggregated calculation result data that is a result thereof to the communication device ET used for a teacher by transmitting the data to the communication device ES used for a student or a mail address registered in the group ID memory 223.

The communication device ES used for a student can display the single calculation result data received from the calculation server 20 through the communication network N or the aggregated calculation result data on the display output device ESD. In addition, the communication device ET used for a teacher can display the aggregated calculation result data received from the calculation server 20 through the communication network N on the display output device ETD or connect the projector P to the communication device ET used for a teacher and project the aggregated calculation result data to be displayed in an enlarged scale.

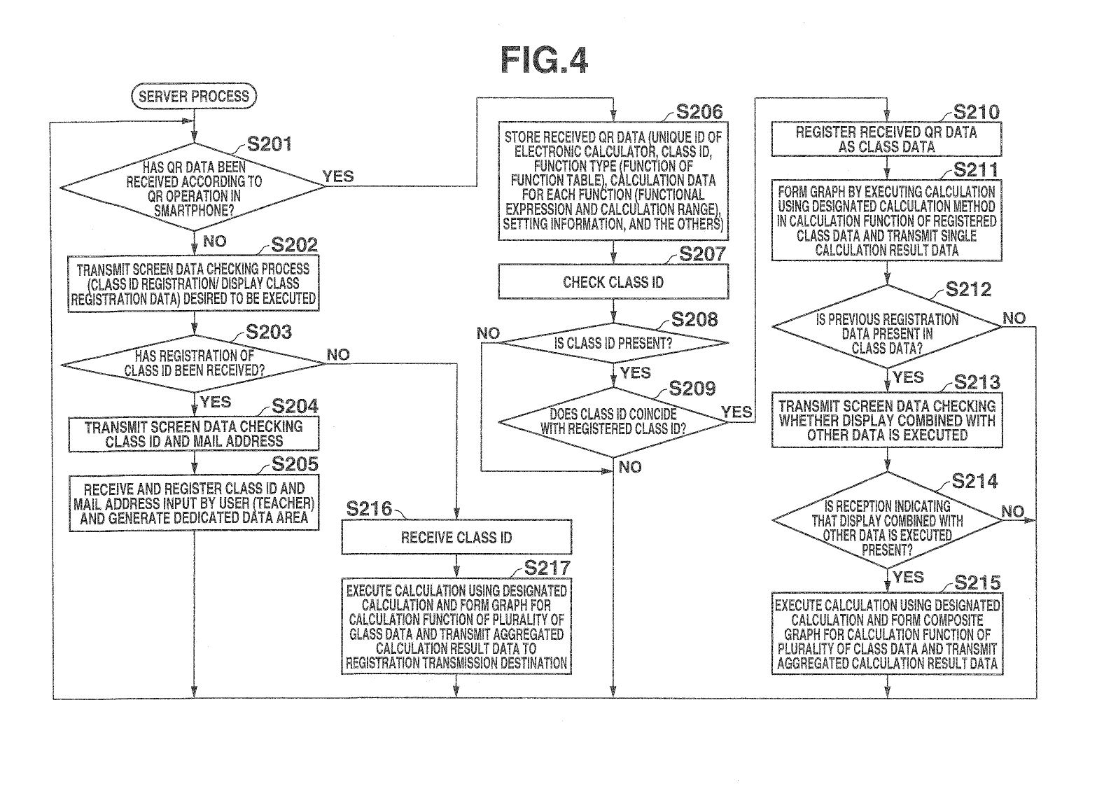

Next, the server processing function of the calculation server 20 having the above-described configuration will be described with reference to a flowchart of a server process illustrated in FIG. 4.

First, when there is reception in the communication device 25 from the communication device ET used for a teacher or a smartphone that is the communication device ES used for a student through the communication network N, the CPU 21 of the calculation server 20 determines whether or not the reception is reception of the QR data according to a QR operation in the smartphone (Step S201).

Here, in a case where the reception is determined not to be the reception of the QR data according to the QR operation, the CPU 21 transmits screen data checking a process (class ID registration/class registration data display) desired to be executed by the smartphone that is the transmission source through the communication network N by using the communication device 25 (Step S202). For example, when the smartphone that is the communication device ET used for a teacher opens a link of a home page of the calculation server 20 by accessing the calculation server 20 or accesses the calculation server 20 from a dedicated application of the smartphone, it is determined that the reception is not the reception of the QR data according to the QR operation in Step S201, and screen data checking a process desired to be executed is transmitted in Step S202. Accordingly, the checking screen is output to be displayed on the display output device ETD of the communication device ET used for a teacher, and the teacher who is a user selects a process desired to be executed.

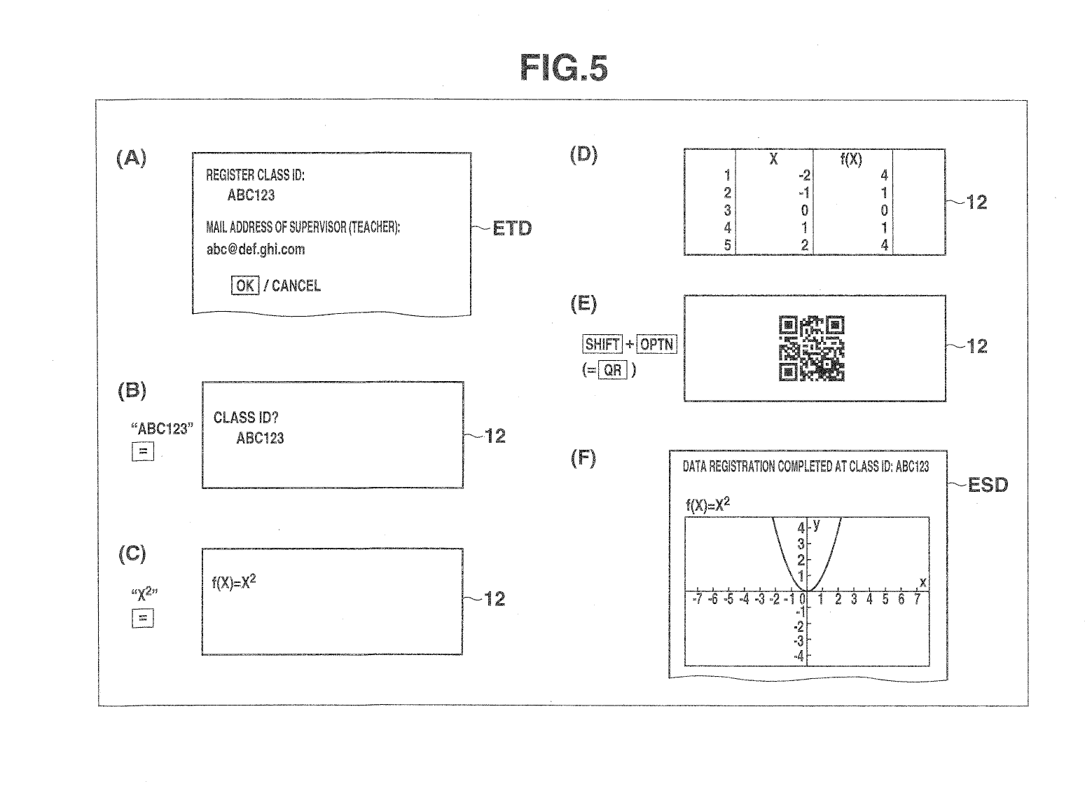

Thus, the CPU 21 determines whether or not the registration of a class ID has been received in accordance with the teacher's operation (Step S203). Here, in a case where it is determined that the registration of a class ID has been received, the CPU 21 transmits screen data checking a class ID and a mail address to smartphone of the transmission source that is the communication device ET used for a teacher through the communication network N by using the communication device 25 (Step S204). In the communication device ET used for a teacher that has received the screen data, a screen checking a class ID and a mail address is displayed on the display output device ETD thereof. Then, as illustrated in part (A) of FIG. 5, as a class ID and a mail address are input, and [OK] is selected, the CPU 21 receives the class ID and the mail address input by the user (teacher) through the communication network N by using the communication device 25, registers the class ID and the mail address in the group ID memory 223 of the memory 22 in association with each other, and the individual class data area 222A dedicatedly used for the class is generated in the registration data memory 222 of the memory 22 (Step S205). Thereafter, the CPU 21 returns the process to Step S201 described above.

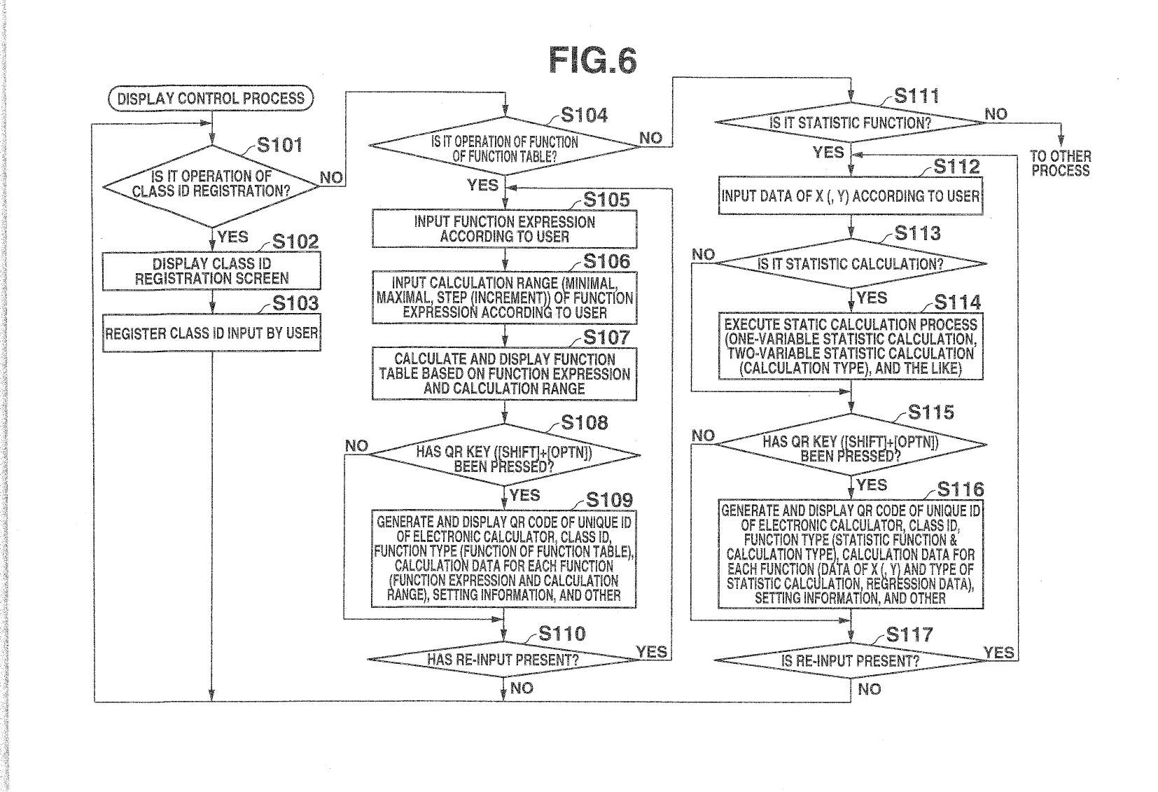

Before the server process is continued to be described, the display control function of the scientific electronic calculator 10 will be described with reference to a flowchart represented in FIG. 6.

For example, in the scientific electronic calculator 10 used by a student A, when the key input device 11 is operated, the CPU 13 determines whether or not the operation is a class ID registration operation (Step S101). Here, in a case where the operation is determined to be the class ID registration operation, the CPU 13 displays a class ID registration screen on the display output device 12 (Step S102). In a case where the student A who is a user, as illustrated in part (B) of FIG. 5, inputs a class ID noticed from the teacher in advance, in this example, “ABC123” by operating the key input device 11 and then operates the execution key [=], the CPU 13 registers the input class ID in the group ID memory 144 of the memory 14 (Step S103). Thereafter, the CPU 13 returns the process to Step S101 described above.

On the other hand, in a case where the operation is determined not to be the class ID registration operation in Step S101, the CPU 13 determines whether or not the operation of the key input device 11 is an execution operation of the function of the function table, in other words, an execution operation of a function of the function table among functions illustrated in a list in accordance with the operation of the [MODE] key (Step S104). Here, in a case where the operation is determined to be the execution operation of a function of a function table, the CPU 13 receives an input of a function expression in accordance with a user operation of the key input device 11 (Step S105). Here, by displaying “f(x)=” for inputting a function expression on the display output device 12 in accordance with the execution operation of the function of the function table, the user is urged to input a function expression. Then, the user, for example, as illustrated in part (C) of FIG. 5, inputs a function expression “x2” by operating the key input device 11 and then operates the execution key [=]. Accordingly, “f(x)=x2” is registered in the input data area 143 of the memory 14 as the function expression.

Thereafter, the CPU 13 receives an input of a calculation range (an initial value, a final value, and a step (increment)) in accordance with a user operation of the key input device 11 (Step S106). For example, the CPU 13, first, displays “Start?” for inputting an initial value on the display output device 12, thereby urging the user to input the initial value. Then, the user, for example, inputs a numerical value [−2] as the initial value by operating the key input device 11 and then, operates the [=] key. In this way, “−2” is registered in the input data area 143 as the initial value. Subsequently, the CPU 13 displays “End?” for inputting a final value on the display output device 12, thereby urging the user to input a final value. Then, the user, for example, inputs a numerical value [2] as the final value by operating the key input device 11 and then operates the [=] key. In this way, “2” is registered in the input data area 143 as the final value. Thereafter, the CPU 13 displays “Step?” for inputting an increment on the display output device 12, thereby urging the user to input an increment. Then, the user, for example, inputs a numerical value [1] as the increment by operating the key input device 11 and then operates the [=] key. In this way, “1” is registered in the input data area 143 as a step. In addition, in Step S105, for example, in a case where a function expression requiring values of variables (in this example, A and B) for the calculation like “f(x)=(A+B)x” is input, inputs of the values of the variables are also received here.

In this way, when the calculation range of the function expression is input, the CPU 13 calculates the function table based on the function expression and the calculation range (and the variables) stored in the input data area 143 and, for example, as illustrated in part (D) of FIG. 5, outputs a result of the calculation to the display output device 12 to be displayed thereon (Step S107).

Thereafter, the CPU 13 determines whether or not the [QR] key, in other words [SHIFT]+[OPTN] keys of the key input device 11 have been pressed (Step S108). Here, in a case where it is determined that the [QR] key has not been pressed, the CPU 13 causes the process to proceed to Step S110 to be described later. On the other hand, in a case where the [QR] key is determined to have been pressed, the CPU 13 generates a QR code of the unique ID of the scientific electronic calculator 10 that is stored in the unique ID 142 of the memory 14, the class ID registered in the group ID memory 144, the function type (here, a function of the function table) of an execution function stored in the input data area 143, calculation target data (for example, a function expression and a calculation range (and variables)) for each function, setting information, and the others and outputs the generated QR code to the display output device 12 to be displayed thereon (Step S109). In addition, although the setting information is not particularly illustrated in the flowchart, the setting information is set in accordance with the operation of [SHIFT]+[MODE] keys (=[SETUP]) of the input device 11 and is stored in the input data area 143. The setting information includes settings of various modes such as an angle mode (a deg (degrees) mode/a rad (radian) mode/a gra (grad) mode), a rounding mode (a Norm (exponential representation) mode/a Fix (fixed number of digits below the decimal point) mode/an Sci (designated significant decimal digits) mode), and a display mode (a LineIO (represented in one line) mode/a MthIO (text display) mode). Accordingly, as illustrated in part (E) of FIG. 5, the image of the QR code is output to the display output device 12 to be displayed thereon. In addition, in a case where the address of the calculation server 20 is set in the numerical expression calculation processing program 141, the QR code may be generated by also using the address of the calculation server. Alternatively, in a case where the address of the calculation server is noticed from the teacher in advance, it may be configured such that the address is registered in the memory 14 together with the class ID, and the address is used for the generation of a QR code together with the class ID.

Thereafter, the CPU 13 determines whether or not there is a re-input of a function expression (Step S110). Here, in a case where it is determined that there is no re-input, the CPU 13 returns the process to Step S101. On the other hand, in a case where it is determined that there is a re-input the CPU 13 returns the process to Step S105.

On the other hand, in a case where the operation is determined not to be the execution operation of a function of the function table in Step S104, the CPU 13 determines whether or not the operation of the key input device 11 is an execution operation of a statistical function, in other words, an execution operation of a statistical calculation function among functions illustrated in a list in accordance with the operation of the [MODE] key (Step S111). Here, in a case where it is determined that the operation is not an execution operation of a statistical function, the CPU 13 causes the process to proceeds to the other processes.

On the other hand, in a case where the operation is determined to be an execution operation of a statistical function, the CPU 13 receives an input of data of X (and Y) in accordance with a user operation of the key input device 11 (Step S112). The input ten units of data of X (and data of ten units of Y) are registered in the input data area 143 of the memory 14.

Thereafter, the CPU 13 determines whether or not an instruction for the process of statistical calculation is received in accordance with a user operation of the key input device 11 (Step S113). Here, in a case where an instruction for the process of the statistical calculation is determined not to have been received, the CPU 13 causes the process to proceed to Step S115 to be described later. On the other hand, in a case where an instruction for the process of the statistical calculation is determined to have been received, a statistical calculation process, in other words, one-variable statistic calculation, two-variable statistic calculation, or the like is executed based on the data registered in the input data area 143 (Step S114). As the calculation types of statistic calculation process, there are linear regression, logarithmic regression, e logarithmic regression, ab exponential regression, exponential regression, inverse regression, secondary regression, and the like, and the statistic calculation of a type (for example, linear regression of two-variable statistic calculation) designated by the user operation is executed.

Thereafter, the CPU 13 determines whether or not the [QR] key, in other words [SHIFT]+[OPTN] keys of the key input device 11 have been pressed (Step S115). Here, in a case where it is determined that the [QR] key has not been pressed, the CPU 13 causes the process to proceed of Step S117 to be described later. On the other hand, in a case where the [QR] key is determined to have been pressed, the CPU 13 generates a QR code of the unique ID of the scientific electronic calculator 10 that is stored in the unique ID 142 of the memory 14, the class ID registered in the group ID memory 144, the function type (for example, a statistical function and a calculation type) of an execution function stored in the input data area 143, and calculation target data (for example, data of X (Y), the type (for example, linear regression of two-variable statistic calculation) of the statistic calculation, and regression data of a calculation result), the setting information, and the others (for example, the address of the calculation server 20) and outputs the QR code to the display output device 12 to be displayed thereon (Step S116).

Thereafter, the CPU 13 determines whether or not there is a re-input of data (Step S117). Here, in a case where it is determined that there is no re-input, the CPU 13 returns the process to Step S101. On the other hand, in a case where it is determined that there is a re-input, the CPU 13 returns the process to Step S112.

As described above, when the QR code is displayed on the display output device 12 by the above-described display control process executed by the scientific electronic calculator 10 of the student, and an image of this QR code is photographed by using the camera-attached smartphone that is the communication device ES used for a student, QR data that is the content of the QR code is analyzed, and the QR data is transmitted from the communication device ES used for a student to the calculation server 20 through the communication network N automatically or in accordance with a user's operation of the communication device ES used for a student. In addition, the address of the calculation server 20 used for the transmission is noticed from the teacher in advance, and a student who is the user inputs the address by operating his communication device ES used for a student. Alternatively, in a case where the address is also generated as the QR code, the address can be extracted from the QR data.

In this way, when the QR data transmitted from the communication device ES used for a student through the communication network N is received using the communication device 25, the CPU 21 of the calculation server 20 determines the reception of the QR data according to a QR operation in Step S201. In such a case, the CPU 21 stores the received QR data, in other words, the unique ID of the scientific electronic calculator 10, the class ID, the function type (for example, a function of the function table, a statistical function, and a calculation type), and calculation target data (for example, a function expression, a calculation range, data of X (Y), the type of the statistic calculation, and regression data), the setting information, and the others in a work area (not illustrated in the figure) used for storing received data that is arranged in the memory 22 (Step S206). Thereafter, the class ID included in the stored QR data is checked (Step S207), and it is determined whether or not the class ID is present (Step S208). Here, in a case where the class ID is determined not to be present, the CPU 21 returns the process to Step S201.

On the other hand, in a case where the class ID is determined to be present in the QR data, the CPU 21 determines whether or not the class ID included in the QR data coincides with the class ID registered in the group ID memory 223 (Step S209). Here, in a case where the class ID is determined not to coincide with the registered class ID, the CPU 21 returns the process to Step S201.

On the other hand, in a case where the class ID is determined to coincide with the registered class ID, the CPU 21 registers the received QR data in the individual class data area 222A of the registration data memory 222 that corresponds to the registered class ID as class data (Step S210). Then, the CPU 21 executes calculation using a calculation method designated for the calculation function of the registered class data so as to form a graph and transmits single calculation result data that is a result thereof to the communication device ES used for a student that is the transmission source through the communication network N by using the communication device 25 (Step S211). Accordingly, as illustrated in part (F) of FIG. 5, the single calculation result data is output to the display output device ESD of the communication device ES used for a student to be displayed thereon.

Thereafter, the CPU 21 determines whether or not registered class data is present in the individual class data area 222A of the registration data memory 222 that corresponds to the registered class ID (Step S212). For example, in the example illustrated in parts (B), (C), (D), and (E) of FIG. 5, only the student A transmits the QR data according to a QR operation, it is determined that registered class data is not present. As above, in a case where the registered class data is determined not to be present, the CPU 21 returns the process to Step S201.

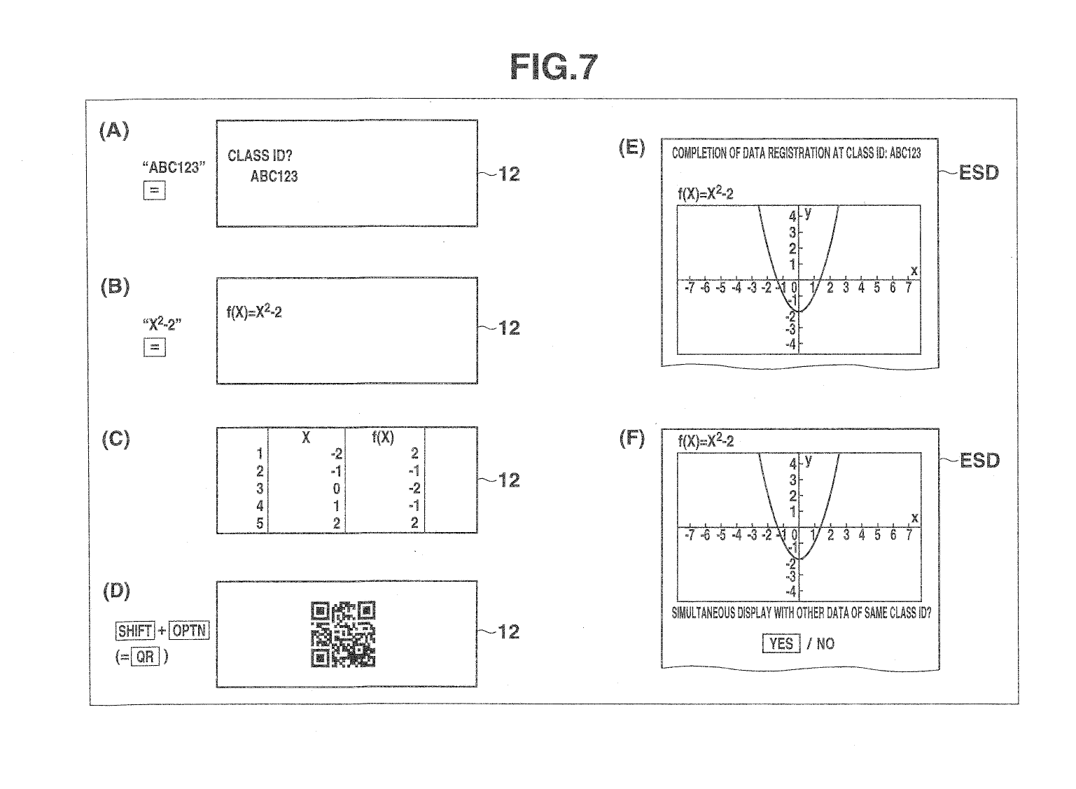

Then, when a student B other than the student A inputs a class ID, as illustrated in part (A) of FIG. 7, by using his scientific electronic calculator 10, for example, inputs a function expression “x2−2” as illustrated in part (B) of FIG. 7, inputs a calculation range of the function expression that is the same as that of the student A, and executes calculation using the scientific electronic calculator 10, whereby, as illustrated in part (C) of FIG. 7, a result of the calculation is output so as to be displayed on the display output device 12. Thereafter, when the student B presses the [QR] key of the key input device 11, in other words, [SHIFT]+[OPTN] keys by using the scientific electronic calculator 10, as illustrated in part (D) of FIG. 7, outputs the image of the QR code so as to be displayed on the display output device 12, and photographs the image using the camera-attached smartphone that is the student B's communication device ES used for a student, QR data that is the content of the QR code is analyzed by the communication device ES used for a student and is transmitted to the calculation server 20 through the communication network N.

In the calculation server 20, when the QR data transmitted from the student B's communication device ES used for a student through the communication network N is received by the communication device 25, the CPU 21 executes the process of Steps S201 and S206 to S211 as described above. Accordingly, as illustrated in part (E) of FIG. 7, the single calculation result data thereof is output so as to be displayed on the display output device ESD of the student B's communication device ES used for a student.

Then, in Step S212, when the CPU 21 determines whether or not registered class data is present in the individual class data area 222A of the registration data memory 222 that corresponds to the registered class ID, as described above, the registered class data for the student A is present in the individual class data area 222A, and accordingly, the registered class data is determined to be present at this time.

In this way, in a case where the registered class data is determined to be present, the CPU 21 transmits screen data checking whether to execute display combined with other data to the student B's communication device ES used for a student that is the transmission source through the communication network N by using the communication device 25 (Step S213). Accordingly, as illustrated in part (F) of FIG. 7, a checking screen is output so as to be displayed on the display output device ESD of the student B's communication device ES used for a student. Then, the CPU 21 determines whether or not reception indicating the execution of display combined with other data is present by using the communication device 25 (Step S214). Here, in a case where it is determined that there is no reception indicating the execution of the display combined with other data, in other words, in a case where “No” is determined to be selected by using the student B's communication device ES used for a student B, the CPU 21 returns the process to Step S201.

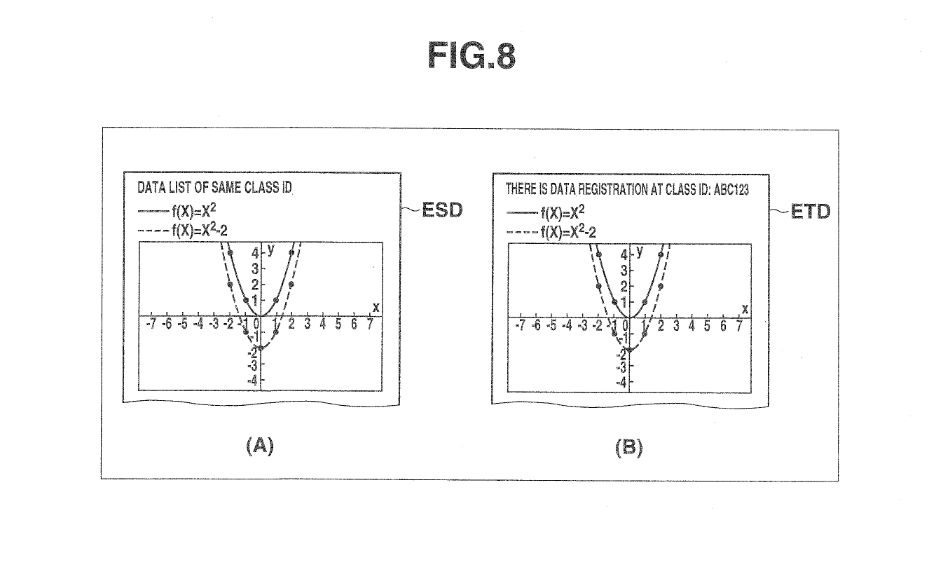

On the other hand, in a case where it is determined that there is reception indicating the execution of display combined with other data, in other words, “Yes” is determined to be selected by using the student B's communication ES device used for a student, the CPU 21 executes calculation using designated calculation in the calculation function of a plurality of class data registered in the individual class data area 222A, composes the results as a graph and transmits aggregated calculation result data that is a result thereof to the student B's communication device ES used for a student, which is the transmission source, through the communication network N by using the communication device 25 (Step S215). Accordingly, as illustrated in part (A) of FIG. 8, the aggregated calculation result data is output so as to be displayed on the display output device ESD of the communication device ES used for a student. In such a case, the line type, the color, and the like are configured to be changed so as to be identified for the display such that the calculation result data of each student can be determined. Then, the CPU 21 returns the process to Step S201.

Meanwhile, when a teacher selects a class registration data display by opening a link of the homepage of the calculation server 20 by accessing the calculation server 20 using the smartphone that is the communication device ET used for a teacher or by accessing the calculation server 20 from an application dedicatedly used by the smartphone, it is determined that no reception of the registration of the class ID is determined in Step S203. In such a case, the CPU 21 receives the class ID input by the communication device ET used for a teacher through the communication network N by using the communication device 25 (Step S216). Then, the CPU 21 executes calculation using designated calculation in the calculation function of a plurality of class data registered in the individual class data area 222A of the registration data memory 222 that corresponds to the class ID, composes the results thereof as a graph, and transmits aggregated calculation result data that is a result thereof to transmission destination information registered in the group ID memory 223 corresponding to the class ID, for example, a rule address through the communication network N by using the communication device 25 (Step S217). Accordingly, as illustrated in part (B) of FIG. 8, by executing an operation of reading the aggregated calculation result data transmitted to the set mail address in the communication device ET used for a teacher, the aggregated calculation result data is output so as to be displayed on the display output device ETD. Also in such a case, similar to the display output from the communication device ES used for a student, the line type, the color, and the like are configured to be changed so as to be identified for a display such that the calculation result data of each student can be determined. In addition, the aggregated calculation result data, as illustrated in FIGS. 1A and 1B, can be projected so as to be displayed in an enlarged scale, by the projector P. Then, the CPU 21 returns the process to Step S201.

In addition, in Step S217, the aggregated calculation result data is configured to be transmitted to a transmission destination represented in the registered transmission destination information, it is apparent that the aggregated calculation result data may be configured to be transmitted to the communication device ET used for a teacher that is the transmission source of the class ID. However, by transmitting the aggregated calculation result data to a transmission destination such as a mail address that is not restricted to a device, for example, the calculation server 20 is requested to display the class registration data by an operation of the smartphone that is the held communication device ET used for a teacher, and resultant aggregated calculation result data can be received by the communication device ET used for another teacher such as a notebook PC that can be easily connected to the projector P at low cost.

Thus, according to the calculation server 20 having the configuration described above, a plurality of group IDs, for example, class IDs are stored in the group ID memory 223 in association with the transmission destination information such as a teacher's mail address, and, when the group ID of each scientific electronic calculator 10 and the calculation target data associated with the group ID are received from the scientific electronic calculator 10 of the student that is an information display device associated with one of the group IDs by using the communication device 25, the CPU 21 registers the received calculation target data in the individual class data area 222A of the registration data memory 222. Then, aggregated calculation result data of the calculated results is acquired by aggregating the registered calculation target data for each group ID, and, the aggregated calculation result data of the calculated results is transmitted to a transmission destination represented in the transmission destination information.

Accordingly, the calculation target data of each information display device is easily registered as a group, and the aggregated result data that is a result of aggregation of a plurality of calculation target data can be output.

In addition, the CPU 21 receives the transmission destination information and the group ID transmitted in accordance with a user operation of the communication device ET used for a teacher by using the communication device 25 and registers the transmission destination information and the group ID in the group ID memory 223.

Accordingly, a teacher who is the user can set an arbitrary transmission destination and an arbitrary group ID.

In addition, the communication device 25, receives the group ID and the calculation target data acquired by photographing an image of a two-dimensional code acquired by forming the group ID and the calculation target data as a two-dimensional code, for example, a QR code by using the communication device ES used for each student in each scientific electronic calculator 10 of each student from the communication device ES used for each student.

Accordingly, a communication function for communicating with the calculation server 20 does not need to be mounted in the scientific electronic calculator 10, and thus, the scientific electronic calculator 10 can be provided at low cost.

In addition, the CPU 21 acquires single calculation result data that is a result of the calculation of the single calculation target data, which is transmitted from the communication device ES used for a student, received by the communication device 25 and transmits the acquired single calculation result data to the communication device ES used for a student that is the transmission source by using the communication device 25.

Accordingly, the communication device ES used for a student can output the transmitted single calculation result data so as to be displayed on the display output device ESD.

Furthermore, the CPU 21 transmits the aggregated calculation result data to the communication device ES used for a student that is the transmission source by using the communication device 25.

Accordingly, the communication device ES used for a student can output not only the single calculation result data according to the calculation target data transmitted thereby but also the aggregated calculation result data acquired by aggregating calculation results according to the calculation target data of the other students so as to be displayed on the display output device ESD.

In addition, the output of the class ID that is the group ID, the calculation target data for each function, and the like from the scientific electronic calculator 10 to the communication device ES used for a student is not limited to the display output of the QR code that is executed by the display output device 12, but as denoted by broken lines in FIG. 2, the output may be an wireless output executed by the wireless communication device 16. In such a case, the communication device ES used for a student receives the class ID, the calculation target data for each function, and the like, which are output in a wireless manner, by using a built-in wireless communication device (not illustrated in the figure) and transmits the class ID, the calculation target data for each function, and the like to the calculation server 20 through the communication network N.

### Second Embodiment

Next, a second embodiment of the present invention will be described.

In this second embodiment, a teacher registers the function type and the form of the calculation target data in the calculation server 20 in advance.

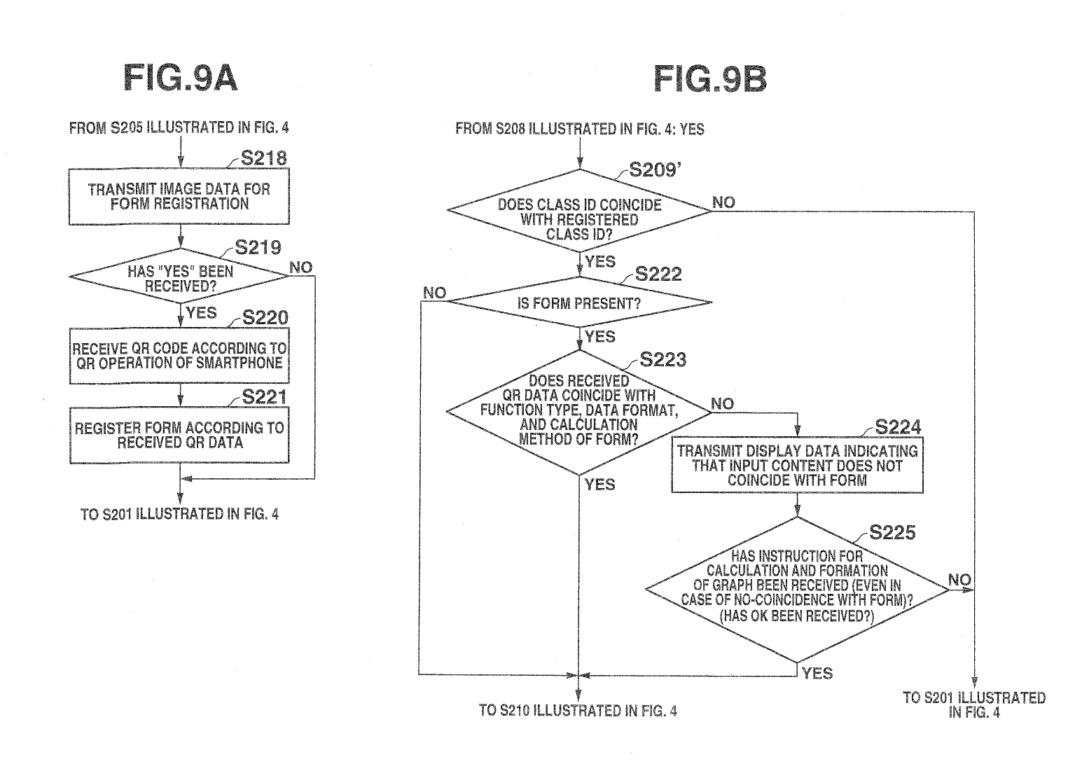

FIGS. 9A and 9B show portions of a flowchart that is executed in addition to the flowchart (FIG. 4) of the server process according to the first embodiment in the second embodiment of the present invention. More specifically, after Step S205 of the server process is executed in the flowchart illustrated in FIG. 4, an additional process (Steps S218 to S221) illustrated in FIG. 9A is executed, and then, the process is returned to Step S201 illustrated in FIG. 4. In addition, after Step S208 of the server process in the flowchart illustrated in FIG. 4 is executed, instead of Step S209 of the flowchart illustrated in FIG. 4, a series of processes starting from Step S209 illustrated in FIG. 9B is executed, and the process is returned to Step S210 illustrated in FIG. 4 or Step S201 illustrated in FIG. 4 in accordance with the content of the process.

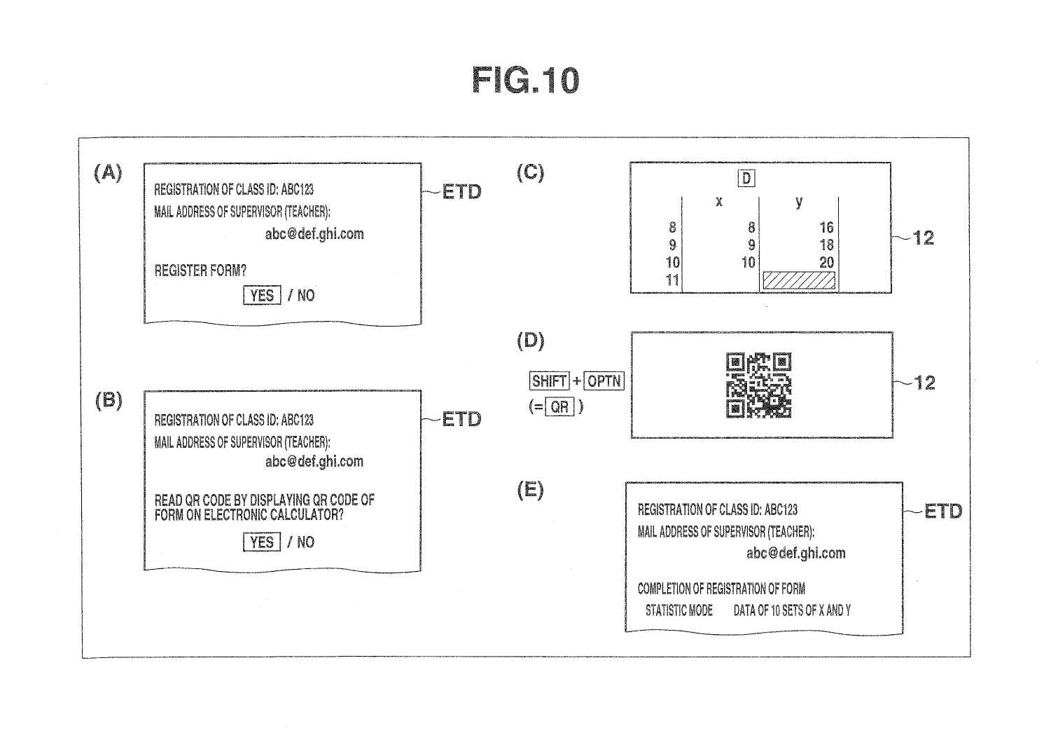

In other words, the CPU 21 of the calculation server 20 registers a mail address in the group ID memory 223 of the memory 22 in association with the class ID in Step S205 illustrated in FIG. 4, and, after the individual class data area 222A is generated in the registration data memory 222, in this embodiment, as illustrated in FIG. 9A, screen data for registering a form through the communication network N by using the communication device 25 is transmitted to the communication device ET used for a teacher that is the transmission source (Step S218). Accordingly, on the display output device ETD of the communication device. ET used for a teacher, as illustrated in part (A) of FIG. 10, a screen for registering a form is displayed. Then, the CPU 21 determines whether or not “Yes” is received through the communication network N by the communication device 25 (Step S219). Here, in a case where it is determined that “Yes” has not been received, the CPU 21 returns the process to Step S101.

On the other hand, in a case where it is determined that “Yes” has been received, the CPU 21 receives QR data according to a QR operation in the smartphone that is the communication device ET used for a teacher through the communication network N by using the communication device 25 (S220). In other words, in the communication device ET used for a teacher, in a case where “Yes” is selected on a form registration screen as illustrated in part (A) of FIG. 10, the display content of the display output device ETD of the communication device ET used for a teacher becomes a QR code reading checking screen as illustrated in part (B) of FIG. 10. Here, the teacher generates a form by using the scientific electronic calculator 10 and generates a QR code thereof. For example, the statistic calculation function is executed among functions illustrated in a list in accordance with an operation of the [MODE] key, and in Step S112, as illustrated in part (C) of FIG. 10, calculation target data for each function (for example, ten data values of each of X and Y and the type of the statistic calculation (for example, linear regression of two-variable statistic calculation)) is input. Then, by pressing the [QR] key, in Step S116, as illustrated in part (D) of FIG. 10, a QR code of the function type and the calculation target data for each function is generated, and the QR code is output to be displayed on the display output device 12. Then, in the communication device ET used for a teacher, by executing a selection operation of “Yes” on the QR code reading checking screen illustrated in part (B) of FIG. 10, the communication device ET used for a teacher reads an image of the QR code displayed on the display output device 12 of the scientific electronic calculator 10 as illustrated in part (D) of FIG. 10 and transmits the QR data that is the content thereof to the calculation server 20 through the communication network N.

When this QR data is received, the CPU 21 of the calculation server 20 registers a form according to the received QR data in the corresponding individual class data area 222A of the registration data memory 222 or the corresponding group ID memory 223 (Step S221). At this time, registration completion may be transmitted to the communication device ET used for a teacher that is the transmission source through the communication network N by using the communication device 25. Accordingly, in the communication device ET used for a teacher, after the transmission of the QR data, automatically or in accordance with the reception of the registration completion, as illustrated in part (E) of FIG. 10, the completion of the registration of the form is output so as to be displayed on the display output device ETD.

Then, when the QR data is received from the communication device ES used for a student, the CPU 21 determines whether or not a class ID is present in Step S208 illustrated in FIG. 4. Then, in a case where a class ID is determined to be present in the QR data (Step S208: Yes), the CPU 21 causes the process to proceed to Step S209′ illustrated in FIG. 9B and determines whether or the class ID included in the QR data coincides the class ID registered in the group ID memory 223. In a case where the class ID is determined to coincide with the registered class ID in Step S209, in this embodiment, the following process is additionally executed. In other words, it is determined whether or not a form is registered in the individual class data area 222A (or the group ID memory 223) corresponding to the class ID (Step S222). Here, in a case where the form is determined not to have been registered, the CPU 21 causes the process to proceed to Step S210.

On the other hand, in a case where the form is determined to have been registered, the CPU 21 determines whether or not the received QR data coincides with the function type, the data format, and the calculation method of the form (Step S223). Here, in a case where the received QR data is determined to coincide with the form, the CPU 21 causes the process to proceed to Step S210.

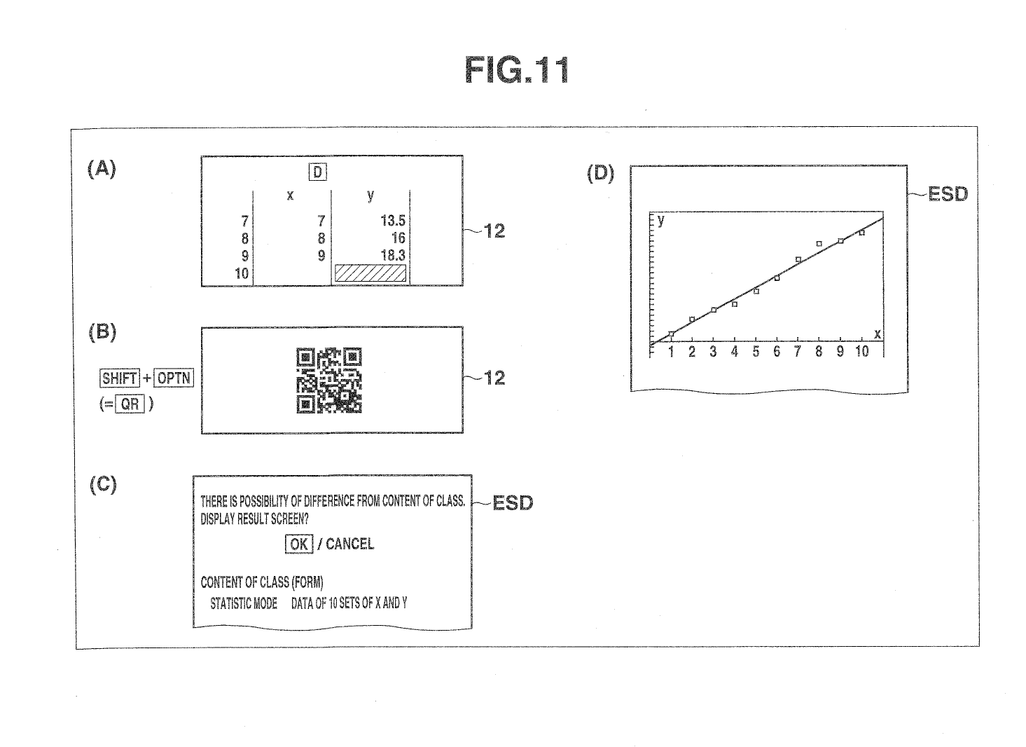

On the other hand, for example, in the communication device ES used for a student, as illustrated in part (A) of FIG. 11, in a case where nine data values of each of X and Y are input, and, as illustrated in part (B) of FIG. 11, a QR code thereof is generated by pressing the [QR] key, the QR data received from the communication device ES used for a student does not coincide with the data format and the calculation method of the form. More specifically, in the QR data received from the communication device ES used for a student, while the data format is “nine data values of each of X and Y”, and the calculation method is “linear regression of two-variable statistic calculation”, in the data format of the form, the data format is “10 data values of each of X and Y” and the calculation method is “linear regression of two-variable statistic calculation”. Thus, while the calculation methods coincide with each other, the data formats do not coincide with each other. In such a case, in Step S223, the CPU 21 determines that the received QR data does not coincide with the form. Then, display data indicating that the input content does not coincide with the form is transmitted to the communication device ES used for a student that is the transmission source through the communication network N by using the communication device 25 (Step S224). Accordingly, as illustrated in part (C) of FIG. 11, the display screen indicating that the input content does not coincide with the format is output and displayed on the display output device ESD of the communication device ES used for a student.

After the display data indicating that the input content does not coincide with the form is transmitted, the CPU 21 determines whether or not an instruction for calculation and formation of a graph even in the case of no coincidence with the form has been received from the communication device ES used for a student through the communication network N, in other words, whether or not “OK” has been received by using the communication device 25 (Step S225). Here, in a case where the instruction for calculation and formation of a graph is determined to have been received, the CPU 21 causes the process to proceed to Step S210.

On the other hand, in a case where the instruction for calculation and formation of a graph is determined to have not been received, in other words, in a case where “Cancel” is determined to have been received, the CPU 21 causes the process to proceed to Step S201. In other words, the student who is the user using the communication device ES used for a student that is the transmission source can notice his mistake based on the display screen indicating that the input content does not coincide with the form as illustrated in part (C) of FIG. 11 and, after inputting a correct content, in this example, 10 data values of each of X and Y by using the scientific electronic calculator 10, generates a QR, and transmits the QR data again from the communication device ES used for a student to the calculation server 20.

In this way, by transmitting correct QR data, the process proceeds from Step S223 to Step S210. Accordingly, in Step S211, the single calculation result data is transmitted from the calculation server 20 to the communication device ES used for a student and, as illustrated in part (D) of FIG. 11, is output and displayed on the display output device ESD.

Thus, according to the calculation server 20 having the configuration described above, by using the communication device 25, the function type and the calculation target data of the form are received from the communication device ET used for a teacher, and, in addition to the group ID and the calculation target data, the function type is further received from the scientific electronic calculator 10 of each student, and, in a case where the function type and the calculation target data that have been received do not coincide with the function type and the calculation target data of the form, the CPU 21 transmits an inappropriateness message to each scientific electronic calculator 10 by using the communication device 25.

Accordingly, the student can notice that incorrect data has been transmitted and thus can transmit correct data again.

In addition, the communication device 25 receives the group ID and the function type and the calculation target data of the form acquired by photographing an image of a two-dimensional code, which is acquired by generating a two-dimensional code, for example, a QR code of the group ID and the function type and the calculation target data of the form in teacher's scientific electronic calculator 10, by using the communication device ET used for a teacher from the communication device ET used for a teacher.

Accordingly, a communication function for communicating with the calculation server 20 does not need to be mounted in the teacher's scientific electronic calculator 10, and thus, the scientific electronic calculator 10 can be provided at low cost.

In addition, the communication device 25 receives the group ID, the function type, and the calculation target data acquired by photographing an image of a two-dimensional code, which is acquired by generating a two-dimensional code, for example, a QR code of the group ID, the function type, and the calculation target data in the scientific, electronic calculator 10 of each student, by using the communication device ES used for each student from the communication device ES used for a student, and the CPU 21 transmits the inappropriateness message to the communication device ES used for a student that is a transmission source by using the communication device 25.

Accordingly, a communication function for communicating with the calculation server 20 does not need to be mounted in the scientific electronic calculator 10 of each student, and thus, the scientific electronic calculator 10 can be provided at low cost. In addition, the calculation target data of each scientific electronic calculator 10 is output and displayed and can be easily registered in the server as a group through the communication device, and aggregated result data that is a result of the aggregation of a plurality of calculation target data can be output.

In addition, any of the technique of each process executed by the calculation server 20 described in each embodiment described above, in other words, each technique of the server process illustrated in the flowchart represented in FIG. 4 and the each technique of the server process illustrated in the flowcharts represented in FIGS. 9A and 9B, and the like may be distributed with being stored in a recording medium 23 such as a memory card (a ROM card, a RAM card, or the like), a magnetic disk (a floppy (registered trademark) disk, a hard disk, or the like), an optical disk (a CD-ROM, a DVD, or the like), a semiconductor memory as a program executable by a computer. In addition, data of a program used for realizing each technique described above may be transmitted on the communication network N in the form of a program code, and, by acquiring this program data by using a communication device 25 in a computer of an electronic apparatus that is connected to the communication network N, the server function described above can be realized.

The present invention is not limited to each embodiment described above but may be variously modified in a range not departing from the concept in an execution stage. In addition, in each embodiment described above, inventions of various steps are included, and various inventions can be extracted according to an appropriate combination of a plurality of disclosed constituent elements. For example, in a case where the object described above can be solved, and the advantages described above can be acquired also when some constituent elements are eliminated from all the constituent elements represented in each embodiment, or when some constituent elements are combined in a different form, a configuration in which such constituent elements are eliminated or combined can be extracted as an invention.

What is claimed is:

1. A server apparatus comprising:
a transmission/reception unit that transmits/receives data to/from at least one communication device; and
a processor,
wherein the processor is configured to:
transmit a group ID to the communication device by using the transmission/reception unit;
receive a plurality of calculation data of calculators from the communication device by using the transmission/reception unit, wherein corresponding images of the plurality of calculation data of calculators were displayed in display devices of calculators, and the plurality of calculation data of calculators of the corresponding images were acquired by the communication device; and
output aggregated calculation data acquired by aggregating the received plurality of calculation data of calculators in association with the group ID.

2. The server apparatus according to claim 1, wherein:
the transmission/reception unit is configured to
transmit/receive data to/from a plurality of camera-attached communication devices as the communication devices; and
the processor is configured to:
transmit each of a different group ID to each of the plurality of camera-attached communication devices,
receive each of the plurality of calculation data of calculators and each of the different group ID from each of the plurality of camera-attached communication devices, wherein two-dimensional code images corresponding to the plurality of calculation data of calculators were displayed in display devices of calculators, and the plurality of calculation data of calculators were acquired by being photographed the two-dimensional code images by each of the plurality of camera-attached communication devices; and
externally output aggregated calculation data acquired by aggregating the plurality of received calculation data of calculators for each of the different group ID.

3. The server apparatus according to claim 1, wherein:
the processor configured to:
transmit/receive data to/from a camera-attached communication device as the communication devices by using the transmission/reception unit;
receive each of the calculation data of calculators and each of a calculator-unique ID from the camera-attached communication devices, wherein two-dimensional code images corresponding to each of the calculation data of calculators and each of the calculator-unique IDs were displayed in a display device of each of the calculators, and each of the calculation data of calculators and each of the calculator-unique ID were acquired by being photographed the two-dimensional code images by the camera-attached communication devices; and
externally output aggregated calculation result data, wherein each of the received calculation data of calculators are aggregated as the aggregated calculation result data distinguishably for each of the received calculator-specific ID.

4. The server apparatus according to claim 1, wherein:
the processor is configured to:
transmit single calculation result data that is a result of calculation of single calculation target data that is transmitted from the communication device and is received by a calculation data reception device to the communication device that is a transmission source.

5. The server apparatus according to claim 1, wherein:
the processor is configured to:
additionally transmit the aggregated calculation result data to the communication device that is a transmission source when the aggregated calculation data that is aggregated is output.

6. The server apparatus according to claim 1, wherein:
the processor is configured to:
receive a function type and calculation target data of a form;
additionally receive a function type from each information display device; and
transmit an inappropriateness message to each information display device in a case where the function type and the calculation target data that are received are not appropriate to the function type and the calculation target data of the form when the aggregated calculation data that is aggregated is output.

7. The server apparatus according to claim 6, wherein:
the processor is configured to:
receive the group ID and the function type and the calculation target data of the form that are transmitted from the communication device acquiring the group ID and the function type and the calculation target data of the form by photographing a two-dimensional code image including the group ID and the function type and the calculation target data of the form displayed by the information display device.

8. The server apparatus according to claim 6, wherein:
the processor is configured to:
receive the group ID, the function type, and the calculation target data of each information display device that are transmitted from a communication device acquiring the group ID, the function type, and the calculation target data by photographing a two-dimensional code image including the group ID, the function type, and the calculation target data displayed by each information display device when the aggregated calculation data that is aggregated is output; and
transmit an inappropriateness message to the communication device that is a transmission source when the inappropriateness message is transmitted.

9. A method of aggregating calculation target data for an electronic apparatus that includes a transmission/reception unit transmitting/receiving data to/from a communication device, the method comprising:
transmitting a group ID to the communication device by using the transmission/reception unit;
receiving a plurality of calculation data of calculators from the communication device by using the transmission/reception unit, wherein corresponding images of the plurality of calculation data of calculators were displayed in display devices of calculators, and the plurality of calculation data of calculators of the corresponding images were acquired by the communication device; and
outputting aggregated calculation data acquired by aggregating the received plurality of calculation data of calculators in association with the group ID.

10. A non-transitory computer-readable storage medium having a program stored thereon for controlling a computer of an electronic apparatus that includes a transmission/reception unit transmitting/receiving data to/from a communication device, to perform functions comprising:
transmitting a group ID to the communication device by using the transmission/reception unit;
receiving a plurality of calculation data of calculators from the communication device by using the transmission/reception unit, wherein corresponding images of the plurality of calculation data of calculators were displayed in display devices of calculators, and the plurality of calculation data of calculators of the corresponding images were acquired by the communication device; and
outputting aggregated calculation data acquired by aggregating the received plurality of calculation data of calculators in association with the group ID.
